(19) United States
(12) Patent Application Publication
(10) Pub. No.: US 2004/0179854 A1
(43) Pub. Date: Sep. 16, 2004

(54) Data dependant biasing for nonlinear devices

(76) Inventor: William Kit Dean, Golden, CO (US)

Correspondence Address: BARLOW, JOSEPHS & HOLMES, LTD., 101 DYER STREET, 5TH FLOOR, PROVIDENCE, RI, 02903, US

(21) Appl. No.: 10/386,832

(22) Filed: Mar. 12, 2003

(51) Int. Cl. H04B 10/02

(52) U.S. Cl. 398/197

(57) ABSTRACT

A way to counter data dependant skewing of biases in transmitted data signals. Data that does not have a random mixture of 11111 and 110″ levels may cause receiving amplifiers to develop a net dc offset or bias. Such an offset may degrade performance. In order to counter such offsets the data can be averaged and a DC offset determined. Using the DC offset to set a bias point for the data transmitter may counteract the DC offset. For example the DC offset may be used to set the levels of light intensity that carry the data in a fiber optic system. The data may have to be slightly delayed at the transmitter while the DC offset is determined, however at high data rates such offsets may be made negligible, and in other non real time systems, for example video delivery systems, even relatively long delays may be negligible.

### FIELD OF THE INVENTION

The present invention relates most generally to the field of transmission of data. More particularly, the present invention relates to biasing of data transmission based on the makeup of the data being transmitted.

### BACKGROUND AND SUMMARY OF THE INVENTION

In the field of telecommunications, lasers such as vertical cavity surface emitting lasers (VCSELs) and other opto-electronic devices are commonly used for the transmission of information along optical fibers and the like. VCSELs, in particular are especially desirable in today's optical communication systems because they are efficient, small in size, readily assembled into arrays, and easy to manufacture.

Within optical communication systems lasers may be modulated about the average power bias point at a modulation level necessary to achieve desired high and low light output power levels, P_{high} and P_{low}.

An optical modulation amplitude (OMA) and an extinction ratio (ER) of the laser, defined as P_{high}-P_{low} and P_{high}/P_{low}, respectively, may be maintained within predetermined limiting values to maintain desired optical signal integrity.

Other components within an optical data transmission system may also effect the quality of the transmission system. For example the electronics used to drive a laser and receive an optical signal also contribute to the overall performance of a data transmission system. For example an optical receiver and amplifier may perform correctly when receiving a data stream comprising a mixture of high and low levels, for example representing the digital values of “1” and “0”, but may tend to accumulate charge in the amplifier when receiving a succession of repeated high levels. Such accumulated charge may effectively raise the bias point of the amplifier. Accordingly when a first low level signal is received there may be a probability that it will be misinterpreted as the accumulated charge may have to be dissipated from the amplifier before the low level can be properly detected. The opposite situation may also occur. When a succession of repeated low levels are received the bias of the receiver amplifier may be reduced such that the next high level received may have a greater than normal probability of being detected as a low level, i.e. being in error.

A common method of measuring the quality of such signals is the bit error rate of the received transmission. The bit error rate is a statistic that quantifies the quality of a communication system by indicating, on average of a received group of bits, how many will be in error. Systems may have a higher bit error rate if the data contains multiple successive signals of one value over a system, which receives data comprising mixed, e.g. random, levels.

Such problems, while illustrated in terms of an optical transmission system, may be equally applied to other, nonoptical, systems. Optical systems are chosen as being particularly illustrative and examples which are likely to be familiar to those skilled in the art.

Accordingly there is a need in the art for ways to reduce the errors due to makeup of the data transmitted.

### SUMMARY OF EMBODIMENTS OF THE INVENTION

In one embodiment of the present invention a method for transmitting data is disclosed. The method includes averaging a data signal to form an average value and adjusting a bias of a transmitter based on the average value.

In yet another embodiment of the present invention a method for transmitting data is disclosed. The method includes averaging a data signal to form an average value, AC amplifying the data signal, and restoring a DC level to the AC amplified data signal using the average value.

In yet another embodiment of the present invention an apparatus for transmitting data is disclosed. The apparatus includes an averaging circuit that accepts the data signal and forms an average value, and circuitry that adjusts a bias of a transmitter based on the average value.

In yet another embodiment of the present invention an apparatus for transmitting data is disclosed. The apparatus includes an averaging circuit that receives and averages a data signal to form an average value, a delaying circuit that accepts the data signal and delays the data signal to form a delayed data signal, AC amplifier that amplifies the delayed data and a DC restoring circuit that restores a DC level to the AC amplified data signal using the average value.

Other objects, features and advantages of the invention shall become apparent as the description thereof proceeds when considered in connection with the accompanying illustrative drawings.

### BRIEF DESCRIPTION OF THE DRAWINGS

The present invention may best understood from the following detailed description when read in conjunction with the accompanying drawings. In the drawings like numbers refer to similar elements throughout.

FIG. 1 is a generalized block diagram illustrating a fiber optic data transmission system.

FIG. 2A is a graphical illustration of the average bias of a receiver amplifier.

FIG. 2B is a graphical illustration of data content altering the average bias of a receiver amplifier.

FIG. 3 is a graphical illustration of a system for data dependant biasing of a transmitter, according to an embodiment of the invention.

FIG. 4 is a graphical illustration of a system in which DC data is received, AC amplified and a correct DC level then restored.

### DETAILED DESCRIPTION OF EMBODIMENTS OF THE INVENTION

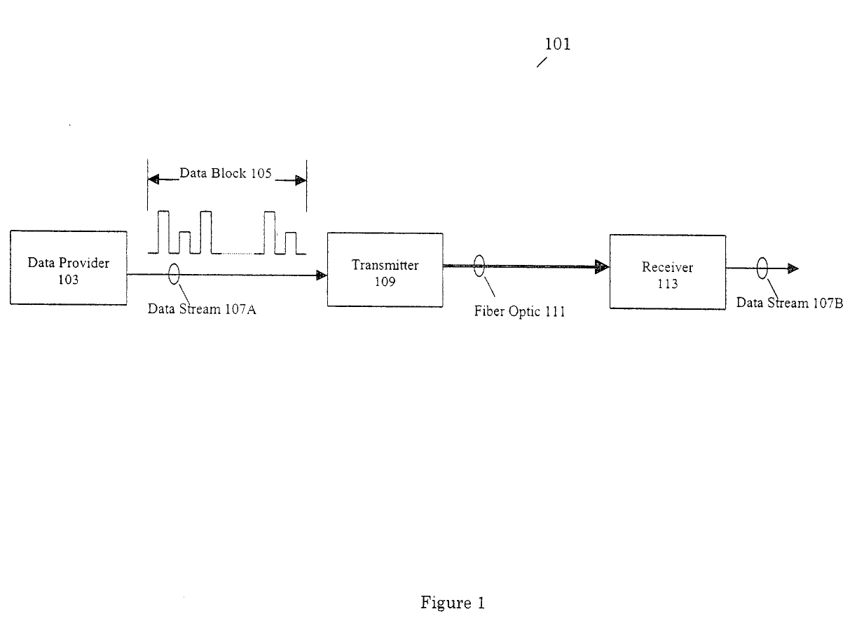

FIG. 1 is a generalized block diagram illustrating a fiber optic data transmission system. FIG. 1 depicts a common data transmission system shown generally at 101. For the purpose of illustration the data transmission system is considered to be a fiber optic data transmission system, but the principles disclosed herein apply equally well to other transmission systems.

In FIG. 1 a data provider 103 provides a data stream 107A. The data stream is divided into successive data blocks 105, as is common in data transmission systems. The data provider may be any type of data provider such as for example a cable television head end, a local network connection, a telephone system, or a Internet connection. It is not, however limited to any of these types of data providers and may accommodate any present or future type of data provider. The data blocks may be any practical size, for example 32 bit blocks.

The data stream is provided to a transmitter 109. For the purposes of illustration and explanation the transmitter will be considered a laser transmitter in which a laser, for example a VCSEL (Vertical Cavity Surface Emitting Laser). The data stream 107A is converted to a transmission signal, which is then provided to a fiber optic 111 for transmission. The transmission signal is commonly a bi-level optical signal in which two different light intensities represent the digital values of “1” and “0”.

The bi-level optical signal is accepted by a receiver 113 and converted into an a data stream 107B, which is commonly an electrical representation of the data stream 107A which has been transmitted. In practice some of the bits of the received data stream 107B will not match the corresponding bits transmitted in data stream 107A. The average number of such bits in error is determined over a quantity of data that is transmitted and is generally known by the term bit error rate or BER. Bit error rate is expressed as errors per thousand bits transmitted or the like.

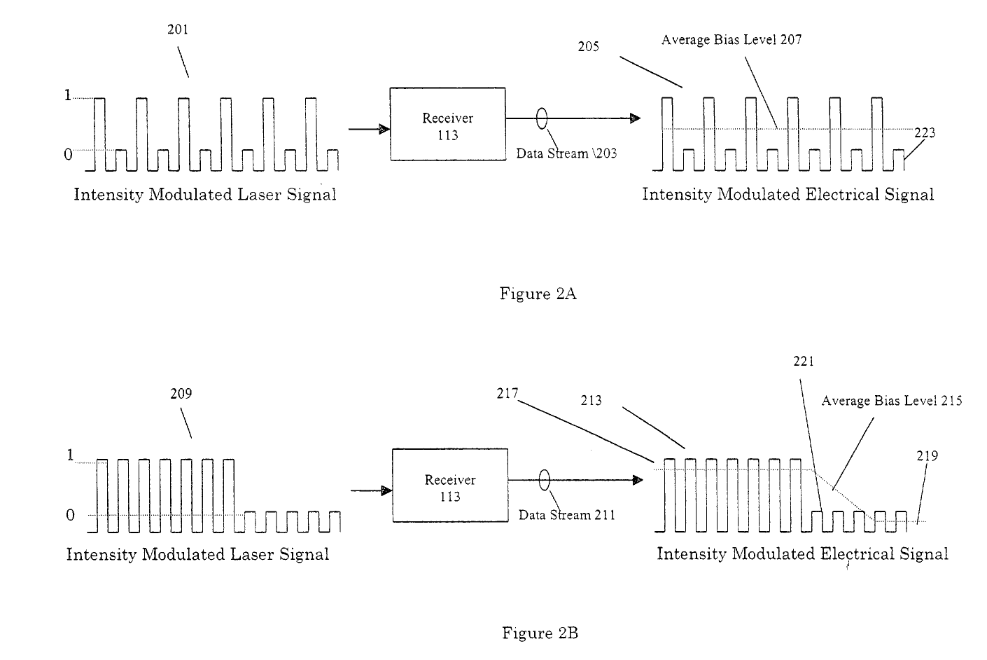

FIG. 2A is a graphical illustration of the average bias of a receiver amplifier. In FIG. 2A intensity modulated laser signal 201 is provided to a receiver 113. The receiver 113 converts the intensity modulated laser signal 201 into a corresponding electrical signal 205. The electrical signal 205 has an average signal level (i.e. a bias level) 207. The average bias level 207 is due to the average of the electrical signal 205, which is present in an amplifier within receiver 113.

FIG. 2B is a graphical illustration of data content altering the average bias of a receiver amplifier. In FIG. 2B intensity modulated laser signal 209 is provided to a receiver 113. The receiver 113 converts the intensity modulated laser signal 209 into a corresponding electrical signal 213. The electrical signal 213 has an average signal level (i.e. a bias level) 215. The average bias level 217 is due to the average of the electrical signal 213, which is present in an amplifier within receiver 113. As may be seen when signal 213 has been at a high level (illustratively a digital “1” value) for a sufficiently long time the average bias value of signal 213 is a first level 217. As also may be seen when signal 213 has been at a low level (illustratively a digital “0” value) for a sufficiently long time the average bias value of signal 213 is a second level 219. When the first “0” value occurs after a string of successive “1s”, i.e. 221 there is an increased likelihood that bit 221 will be incorrectly detected as a “1”. The receiver bias is at a high level 217 just prior to pulse 221 and the “0” pulse 221 must discharge a higher level of bias, essentially 217, than must a corresponding pulse, e.g. pulse 223 in FIG. 2A which must only discharge a bias level of 207.

The rate of change between a first bias level 217 and a second bias level 219 has been somewhat artificially exaggerated for the purposes of illustration. A high average bias may in fact affect multiple pulses after a transition from a sequence of high pulses to a sequence of low pulses as illustrated in FIG. 2B.

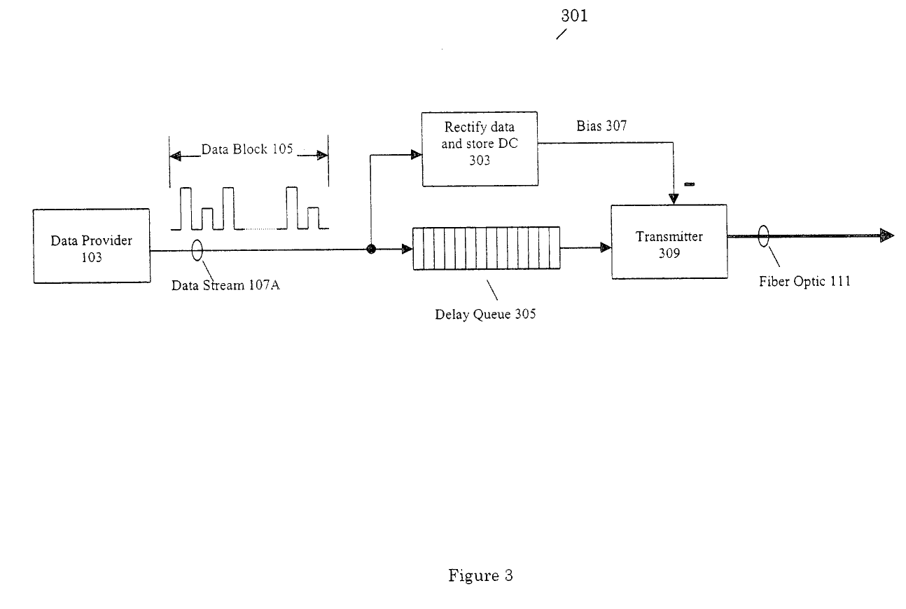

FIG. 3 is a graphical illustration of a system for data dependant biasing of a transmitter, according to an embodiment of the invention. In FIG. 3 data provider 103 provides a data stream in terms of blocks of data 103. The blocks of data are somewhat arbitrary in size and may be increased or decreased depending on the parameters of the particular application being considered. For example the larger the data block 105 the larger the delay Queue 305 must be.

A block of data is provided to delay queue 305. The data is then delayed by a time equal to essentially the length of the queue times the rate at which data enters the queue. The length of the delay queue 305 will be, in part, limited by the delay that is acceptable in the transmission system 301. For example a long delay may be tolerated in a transmission system which transports video, however a system that transports telephone conversations can accommodate only a much shorter delay time. The block of data provided to queue 305 is delayed by the time it takes to transport the data through the queue

Concurrently with providing a block of data 105 to a delay queue, the block of data 105 is also provided to a block which predicts the resulting bias that will be generated by the block of data. The bias prediction may be accomplished by a block such as the rectify data and restore DC block 303. Those skilled in the art will recognize that the average DC bias may be generated in a variety of ways, such as by a computer averaging or the like. once the bias that will result from patterns in the data block 105 are determined they may be counteracted buy adding in a bias value equal to the negative of the bias value. The negated bias 307 can then be added to the transmitted signal in the transmitter, prior to being provided to the fiber optic 111. In such a way the errors caused by a long sequence of the same value can be ameliorated. Additionally the nonlinearities of the transmitter system 309, especially those resulting from odd harmonics, which impart DC levels by their nature. A constant value, representing the nonlinearity of the transmitter 309 may be added (or subtracted depending on the sign of the offset generated by the transmitter 309) in order to further counteract the effects of bias on the data signal.

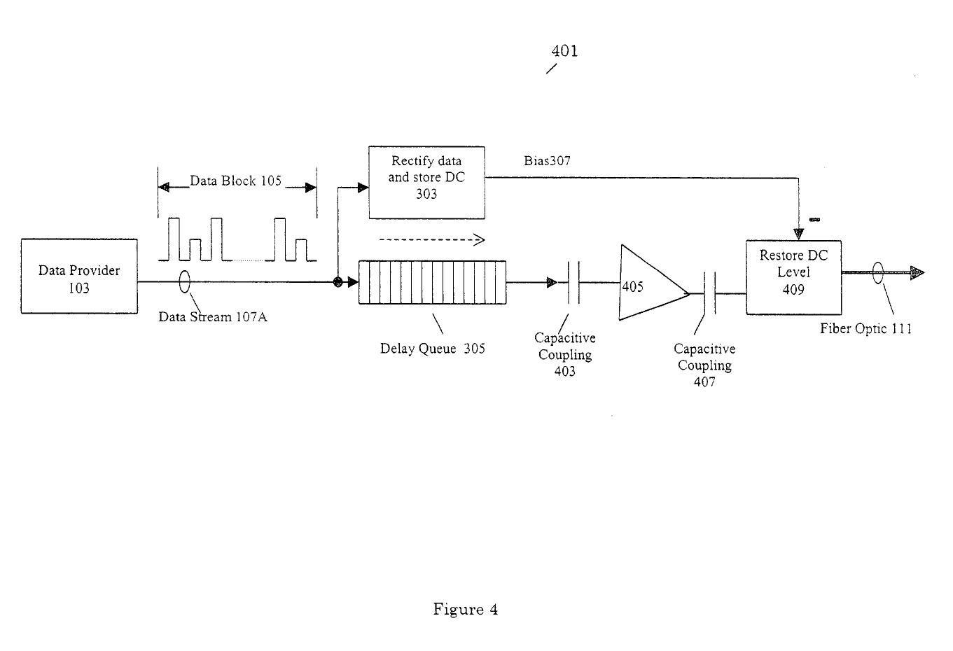

FIG. 4 is a graphical illustration of a system in which DC data is received, AC amplified and a correct DC level then restored. In general DC amplifiers are more costly than AC amplifiers. In FIG. 4, the data to be transmitted is provide to the delay queue 305 in an identical manner to that described and illustrated with respect to FIG. 3. In FIG. 4 however one the data has exited the delay queue it is coupled into amplifier 405 via a capacitive coupling 403. The amplifier amplifies the data provide to it and then the amplified data is capacitatively coupled to a restore DC level block 409. The DC level block 409 receives the bias 307 generated by the data pattern of the block of data, 105, provided. The bias is then negated and used to restore a DC level to the data block 105, which is being processed. The signal then provided to the fiber optic 111 may have the necessary DC shift to compensate for the bias introduced by the content of the data. In such a manner less expensive AC amplifiers may be used. DC amplifiers may be used to provide the necessary bias for the data block to be transmitted, however the cheaper AC amplifiers may be used for the amplification and then a correct remedial DC bias restored via the restore DC level block 409. In such a way the rectify data and restore DC module may be used to determine a level that is needed for the fiber optic, while eliminating the need for more expensive DC amplifiers altogether.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed is:

1. A method of transmitting data comprising:
averaging a data signal to form an average value;
adjusting a bias of a transmitter based on the average value.

2. The method of claim 1 wherein averaging a data signal comprises rectifying and storing a DC level of the data signal.

3. The method of claim 1 wherein adjusting a bias of a transmitter comprises adjusting the bias of a laser transmitter.

4. The method of claim 1 wherein adjusting a bias of a transmitter comprises adjusting the bias of a VCSEL (Vertical Cavity Surface Emitting Laser) transmitter.

5. The method of claim 1 further comprising:
delaying the data signal;
providing the delayed data signal to the transmitter; and
applying the average value to the transmitter bias while the delayed data signal is being transmitted.

6. The method of claim 5 further wherein applying the average value to the transmitter bias while the delayed data signal is being transmitted comprises creating a bi-level transmission signal.

7. The method of claim 5 further wherein applying the average value to the transmitter bias while the delayed data signal is being transmitted comprises creating a bi-level light intensity transmission signal.

8. The method of claim 1 wherein averaging a data signal to form an average value comprises averaging a block of data to form an average value.

9. The method of claim 1 wherein averaging a data signal to form an average value comprises averaging a block of data comprising 32 bits to form an average value.

10. A method of transmitting data comprising:
averaging a data signal to form an average value;
AC amplifying the data signal; and
restoring a DC level to the AC amplified data signal using the average value.

11. The method of claim 10 wherein averaging a data signal comprises rectifying and storing a DC level of the data signal.

12. The method of claim 1 wherein restoring a DC level to the AC amplified data signal comprises adjusting the bias of a transmitter.

13. The method of claim 10 wherein restoring a DC level to the AC amplified data signal using the average value comprises adjusting the bias of a laser transmitter using the average value.

14. The method of claim 10 further comprising:
delaying the data signal;
AC coupling the delayed data signal;
providing the AC coupled and delayed data signal to a DC restoration circuit; and
applying the average value to the DC restoration circuit while the AC coupled and delayed data signal is being DC restored.

15. The method of claim 14 further comprising creating a bi-level transmission signal.

16. The method of claim 14 further wherein applying the average value to the transmitter bias while the delayed data signal is being transmitted comprises creating a bi-level light intensity transmission signal.

17. The method of claim 10 wherein averaging a data signal to form an average value comprises averaging a block of data to form an average value.

18. The method of claim 1 wherein averaging a data signal to form an average value comprises averaging a block of data comprising 32 bits to form an average value.

19. A apparatus for transmitting data comprising:
an averaging circuit that accepts the data signal and forms an average value;
circuitry that adjusts a bias of a transmitter based on the average value.

20. The apparatus of claim 19 wherein the averaging circuit comprises:
a rectifier that rectifies the data signal thereby forming a rectified data signal; and
an integrating circuit that accepts the rectified data signal and creates a DC level of the data signal from the rectified data signal.

21. The apparatus of claim 19 wherein the transmitter comprises a laser transmitter.

22. The apparatus of claim 21 wherein the laser transmitter is a VCSEL (Vertical Cavity Surface Emitting Laser) transmitter.

23. The apparatus of claim 19 further comprising:
a delay means for delaying the data signal;
a transmitter bias input for providing the delayed data to the transmitter;
an average value circuit that creates an average value of the data signal;
a storage device that stores the average value of the data signal to apply to the transmitter while the delayed data is being transmitted.

24. The apparatus of claim 23 wherein the delay means comprises a queue.

25. An apparatus that transmits data comprising:
an averaging circuit that receives and averages a data signal to form an average value;
a delaying circuit that accepts the data signal and delays the data signal to form a delayed data signal;
AC amplifier that amplifies the delayed data; and
a DC restoring circuit that restores a DC level to the AC amplified data signal using the average value.

26. The apparatus of claim 25 wherein the averaging circuit comprises a circuit that integrates the data signal.

27. The apparatus of claim 25 wherein a DC restoring circuit that restores a DC level to the AC amplified data signal comprises a bias level circuit of a transmitter.

28. The apparatus of claim 27 wherein the transmitter comprises a laser transmitter.

29. The apparatus of claim 28 wherein the laser transmitter comprises a VCSEL laser transmitter.

30. An apparatus for transmitting data comprising:
means for averaging a data signal to form an average value; and
means for adjusting a bias of a transmitter based on the average value.

31. An apparatus for transmitting data comprising:
means for averaging a data signal to form an average value;
means for AC amplifying the data signal; and
means for restoring a DC level to the AC amplified data signal using the average value.
